(19) United States
(12) Patent Application Publication
(10) Pub. No.: US 2016/0344338 A1
(43) Pub. Date: Nov. 24, 2016

(54) Profiled-Rail Retaining Element Having Protuberances for a Mechanical and Electrical Connection

(71) Applicant: Everest Solar Systems, LLC, Oceanside, CA (US)

(72) Inventors: Veit Schutz, Stuttgart (DE); Timothy Vaughn, Edgewood, NM (US)

(21) Appl. No.: 15/231,111

(22) Filed: Aug. 8, 2016

Related U.S. Application Data
(60) Provisional application No. 62/202,479, filed on Aug. 7, 2015.

(51) Int. Cl. H02S 40/34; F16M 13/02; H01R 13/627; F16B 1/00

(52) U.S. Cl. CPC H02S 40/34; F16B 1/00; F16M 13/02; H01R 13/6273; F16B 2001/0064

(57) ABSTRACT

A method and system for facilitating quick and easy installation of structural components used in solar mounting systems. In an aspect, the system includes a retaining element configured to secure a solar panel module or other racking components to a rail. The retaining element can create a mechanical and electrical connection between components. In an aspect, the retaining element includes a retainer cap and a base member. In an aspect, the retainer cap and the base member are configured to secure solar components to the rail. In an aspect, the rail retaining element includes a connector that is configured to hold the retainer cap, the base member, and solar panel or like component together.

### CLAIM OF PRIORITY

This application claims priority to U.S. Provisional Patent Application No. 62/202,479, filed on Aug. 7, 2015, which is relied upon and incorporated herein in its entirety by reference.

### FIELD OF THE INVENTION

This invention relates generally to fastening devices for providing a structural connection. More specifically, the invention relates to a retaining or holding element for providing a mechanical and electrical connection in a guide inner profile of a profiled rail comprised of electrically conductive material.

### BACKGROUND OF THE INVENTION

Electrically conductive material, such as aluminum and copper, are used in numerous applications in which it is desired to provide both a physical and electrical connection between different structural components. For example, in structural systems and hardware used for solar panels or other photovoltaic arrangements, it is common to employ rails and fastening components (bonding elements) that require both a mechanical and electrical (such as for grounding purposes) connection.

Solar panels, mounts, and associated structural hardware are commonly installed on roofs or other elevated location. While working in such locations, installers need to be quick and efficient. Routinely, additional hardware components are used in combination with a bolt, screw, or structural component to provide an electrically interfaced structural connection. Additional hardware components increase the overall cost of mounting systems, while also increasing the time and effort required to install the components.

Because solar panel mounting systems are subjected to adverse conditions, rails or other structural components may be painted, anodized, treated with a protective coating, or coated with another layer of metal to provide for long-term life. To form an adequate electrical connection, it is necessary to penetrate any non-conductive layers or skin of the rail or other structural components, including dirt, paint and corrosion, to provide the necessary electrical connection to the base metal.

Hardware bonding elements suitable for fixing together, both mechanically and electrically, a mounting system rail or other associated components without requiring additional hardware are desirable. Further, it is desirable that bonding element be of simple construction and relatively low cost. These desirable attributes have not been found in a single device.

Thus, a need exists in the industry to address the aforementioned challenges.

### SUMMARY OF THE INVENTION

Solar mounting and structural components require appropriate means of bonding and grounding due to regulations. Embodiments of the present invention provide a retaining element for facilitating quick and easy installation of structural components commonly used in solar mounting systems. In an aspect, the retaining element is configured to secure a solar panel module or other racking components to a rail, forming a bond between the retaining element and the rail. In an aspect, the retaining element can be utilized in any situation where it is desired to achieve both a mechanical and electrical connection/bond between components.

In an aspect, the retaining element is configured to provide a mechanical and electrical connection to various solar mounting systems. In an aspect, the retaining element includes fixing elements that are configured to create the electrical and mechanical connection to the various components of solar mounting systems. In an exemplary aspect, the fixing elements can comprise protuberances that are configured to engage conductive layers of solar mounting systems, and in some cases, penetrate non-conductive layers of the solar mounting systems, to create electrical connections with the conductive layers of the components of the solar mounting system. The protuberances can have various structures, including, but not limited to, hemispherical, pyramidal, prismatic, ramp-shaped or any similar structure that serve to engage conductive layers and penetrate a non-conductive layer on a rail or similar structural connection, such as L-feet, module clamps, climbers, and other component connections within a solar mounting system. In an embodiment, the fixing element is of a material that is stronger than the conductive rail material, as well as any non-conductive layer.

In an aspect, the rail retaining element includes two general components: a retainer cap and a base member. In an aspect, the retainer cap and the base member are configured to secure the solar panel to a rail, with the base member slidably engaging an interior profile of the rail and the cap configured to engage the solar panel, or other solar component, and the top of the rail. In an aspect, the rail retaining element includes a connector that is configured to hold the retainer cap, the base member, and solar panel or like component together.

Other features and advantages of the invention will become apparent to one with skill in the art upon examination of the following drawings and detailed description. It is intended that all such additional features and advantages be included herein within the scope of the present invention.

### BRIEF DESCRIPTION OF THE FIGURES

FIG. 1 is a perspective view of the rail retaining element.

FIG. 2 is a side view of the rail retaining element shown in FIG. 1.

FIG. 3 is a perspective view of the retainer cap of the rail retaining element.

FIG. 4 is a perspective view of the base member of the rail retaining element.

FIGS. 5-14 provide perspective views of the different embodiments of the base member of the rail retaining element.

FIG. 15 is a perspective view of a rail retaining element connecting a solar panel module with a railing.

FIG. 16 is a front plan view of an end of the rail retaining element connecting the solar panel module with the railing.

FIG. 17 is a sectional view taken along lines A-A of FIG. 16.

FIG. 18 is a side plan view of the rail retaining element connecting the solar panel module with the railing.

FIG. 19 is a cross-sectional view taken along lines C-C of FIG. 18.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In addition, the figures of the drawings show the invention subject matter highly schematized and are not scaled. The individual components of the subject of the invention are represented in such a way that its structure can be shown well.

In the following description, numerous specific details are set forth. However, it is to be understood that embodiments of the invention may be practiced without these specific details. In other instances, well-known methods, structures and techniques have been shown in detail in order not to obscure an understanding of this description.

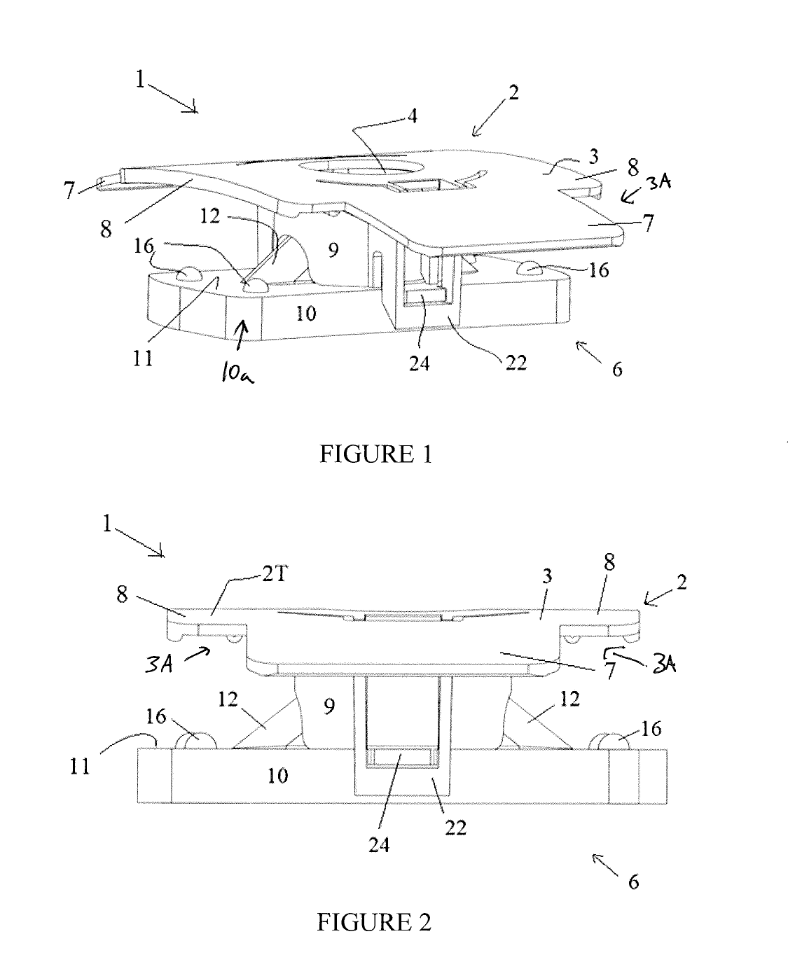

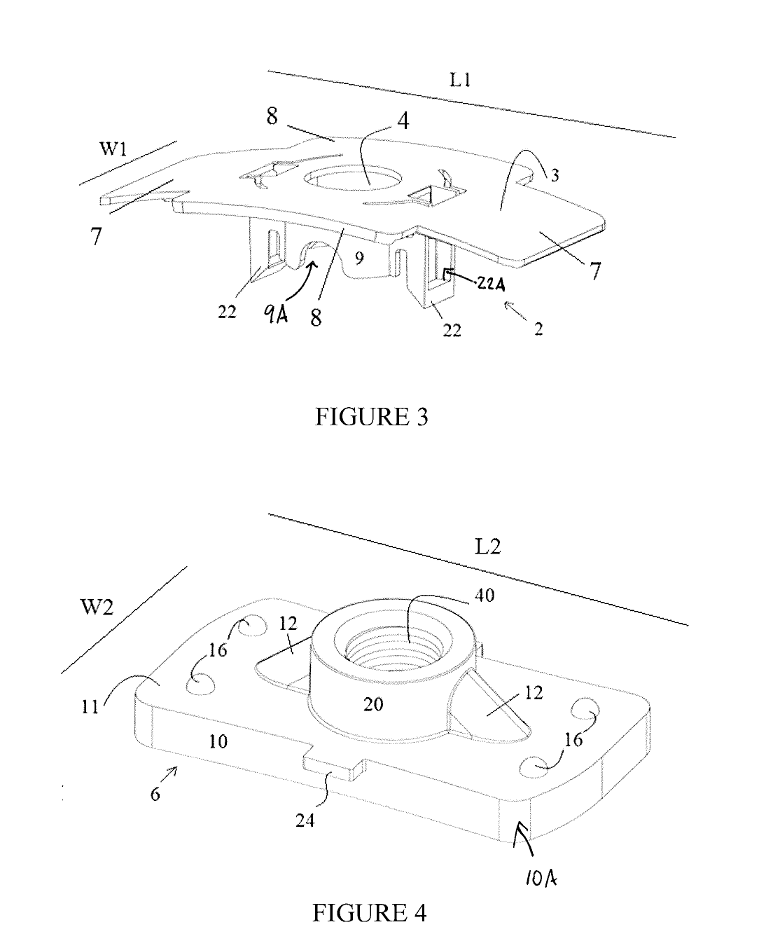

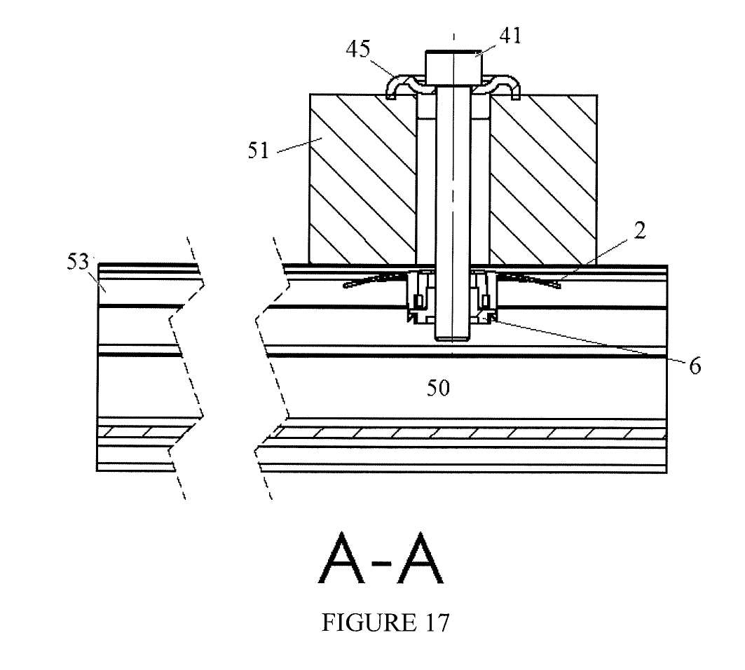

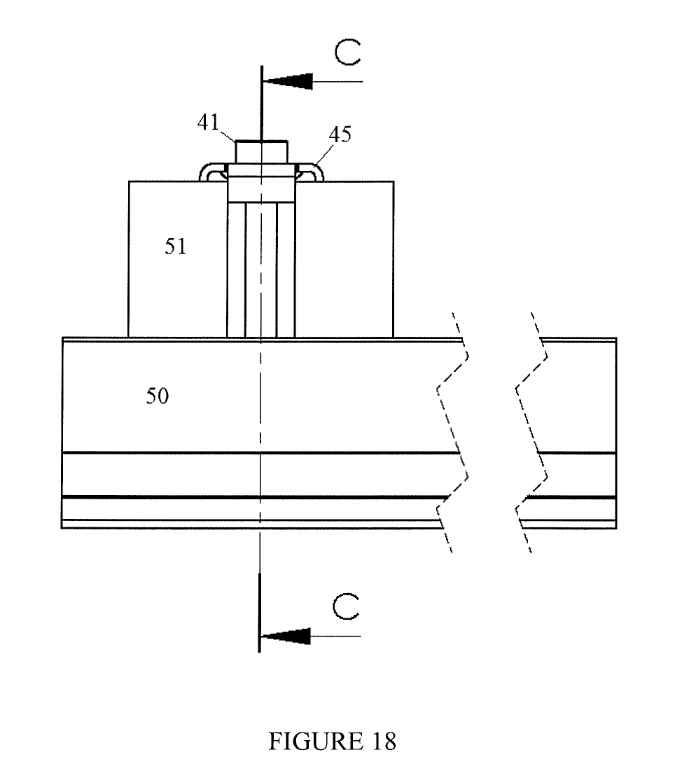

The present invention, as shown in FIGS. 1-19, is directed at a rail retaining element 1. The rail retaining element 1 is configured to provide a mechanical and electrical connection or bond between a solar panel rail and other solar power array components (see FIGS. 15-19), including, but limited to, photovoltaic panels, racking components, wind deflectors, ballast pans, roof anchors, and the like commonly used in solar mounting systems. In an exemplary aspect, the retaining element 1 is designed for arrangement in an inner profile of a rail 50 and to secure a solar component 51 mechanically and electronically to the rail 50.

In an aspect, the rail retaining element 1 includes three main elements: a retainer cap 2 (see FIGS. 1-3), a base member 6 (FIGS. 1, 4-14), and a connector 41 (FIGS. 15-19). The combination of the retainer cap 2, base member 6, and connector 41 act together to keep solar system components 51 connected to a solar railing 50. More specifically, and discussed in more detail below, the base member 6 and the retainer cap 2 are placed within an inner profile of a rail 50, with the retainer cap 2 placed between the solar system component 51 and the base member 6, with a connector 41 securing the retainer cap 2 and base member 6 together. The combination of the components of the rail retaining element 1 and their interaction with the rail 50 and the solar system components 51 are discussed in detail below.

In an aspect, the retainer cap 2 is configured to have a flexible platform 3 with a width W1 and a length L1. The flexible platform 3 forms a top surface 2T configured to engage the bottom surface of the solar system component 51. In an aspect, the top surface 2T forms a substantially rectangular pad surface that is configured to engage the bottom surface of the solar system component 51. The retainer cap 2, and more specifically the flexible platform 3, can be made of flexible material, including, but limited, plastics, sheet metal, and the like. The flexibility of the flexible platform 3 allows the retainer cap 2 to be inserted into the profile of the rail 50, discussed in more detail below. In an aspect, two arms 7 can extend along the outer length from the platform 3, and two shoulders 8 extend along the width from the platform 3. The arms 7 can be configured to be shorter in width than the majority of the flexible platform 3, with the shoulders 8 extending out beyond the sides of the arms 7, forming notched portions 3a of the flexible platform 3. In addition, the flexible platform 3 can take a curved shape, as shown in FIGS. 1-3.

A spacer collar 9 centrally extends from the bottom of the flexible platform 3. The space collar 9 can be configured to engage with components of the base member 6. A centrally located aperture 4 extends through the spacer collar 9 to the center of the flexible platform 3. The aperture 4 is configured to receive the connector 41. In an aspect, the spacer collar 9 includes notches 9a that are configured to engage with portions of the base member 6 discussed below. Applied on the outer surfaces of distance spacer collar 9 are latching arms 22 that are intended for the horizontal and vertical locking of the spacer collar 9 around a neck attachment 20 of the base member 6 about the periphery of the distance spacer collar 9, discussed in detail below.

The base member 6 includes a slide plate 10. The slide plate 10 has a width W2 and a length L2. In an aspect, the slide plate 10 can be configured to be shaped to slidably move within the inner profile of the rail 50, discussed in detail below. The slide plate 10 may have a variety of shapes, but in the illustrated embodiment, it has an essentially rectangular basic shape, with rounded-off, chamfered, or otherwise relieved edges, allowing the slide plate 10 to easily engage the inner profile of the rail 50. In an aspect, the rounded edges/corners 10a allow for the controlled insertion of the slide plate 10 into profile of the rail 50, discussed below.

Extending from a top surface 11 of the slide plate 10 are fixing elements 16, discussed below, and a neck attachment 20. In an aspect, the neck attachment 20 can be cylindrical. In other aspects, the neck attachment 20 can have various shapes, but should correspond in shape to the space collar 9. In most aspects, the shape of the neck attachment 20, as well as the space collar 9, will correspond with the shape of the connector 41. In an aspect, the neck attachment 20 on the guiding slide plate 10 is reinforced by means of two reinforcing ribs 12. The reinforcing ribs 12 assist in preventing the sliding plate 10 and the neck attachment 20 from bending under tension load, which could lead to the mechanical failure of the combination of the retainer cap 2 and base member 6. In an aspect, the notches 9a of the spacer collar 9 are configured to match the profile shape of the reinforcing ribs 12.

The base member 6 may be produced as a single piece, such as a cast member, or it may comprise multiple elements joined together. The slide plate 10, via the neck attachment 20, can be connected to the screw lead-through/aperture 4 of the retainer cap 2 in the longitudinal axis direction of the basic shape of the spacer collar 9. A base aperture 40 extends through the neck attachment 20 which can align with the aperture 4 of the space collar 9. In an aspect, the base aperture 40 is threaded. In such aspects, the thread of the base aperture 40 runs in longitudinal direction of cylindrical base of the neck attachment 20. Nibs 24 can extend from the side of the slide plate 10, so that when the spacer collar 9 surrounds the neck attachment 20 the latching arms 22 will engage the nibs 24. In an aspect, the apertures 22a of the latching arms 22 are configured to receive and engage the nibs 24.

On the upper surface 11 of the slide plate 10 are various fixing elements 16 that serve to penetrate the materials of the rail, conductive and non-conductive, of the rail 50, spacer, or similar element. In an aspect, the fixing elements 16 can comprise protuberances. The protuberances 16 may have a variety of shapes, such as an elevated hemispherical shape, square, pyramidal, prismatic or other related shape, as shown in FIGS. 4-14. In an aspect, the protuberances 16 are comprised of electrically conductive material, including, but not limited to, stainless steel. Regardless of the materials used for the protuberances 16, it is desirable that the protuberances 16 be made of a material that is electrically conductive and harder the material of the rail 50. Discussed in more detail below, the protuberances 16 are configured to create an electrical connection between the base member 6, the rail 50, and the solar component 51.

As discussed above, a connector 41 secures the cap 2 and the base member 6 of the retaining element 1 together to mechanically and electronically connect a solar component 51 with the rail 50. In an aspect, the connector 41 can be comprised of various fasteners, including, but not limited to, hex bolts, allen bolts, and various other bolts and fasteners used to secure components together. The surface of the connector 41 may be smooth, or the surface may feature a thread. The thread may be a helical structure used to convert between rotational and linear movement (force). In some aspects, the surface of the connector 41 may be a combination of a partial thread and smooth surface. In an aspect, the connector 41 includes a matching threaded surface to engage the threaded surface of the base aperture 40 of the neck attachment 20 of the base member 6. In an aspect, a connector 41 engages a clamp 45 that engages the solar module 50. In some instances, however, the connector 41 can include a top flange that eliminates the need for the clamp. In either case, the connector 41 further engages the base member 6 as described herein, such that when the connector 41 firmly engages the base member 6 and is tightened, the clamp 45 will lock the solar module 51 with the rail 50, drawing the base member 6 into close engagement with the rail 50.

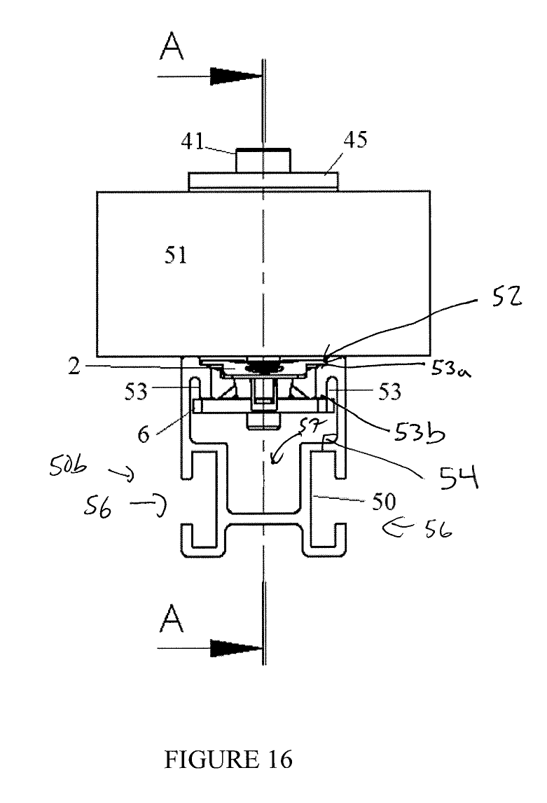

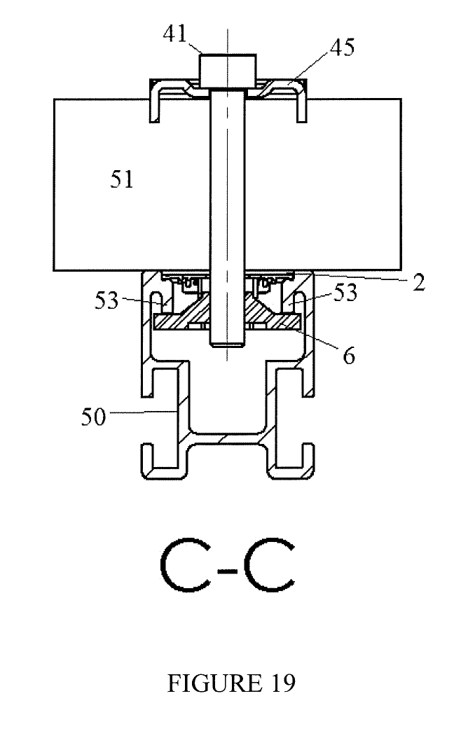

In an aspect, the rail retaining element 1 is designed for arrangement in a guide inner profile of a profiled rail 50. In an aspect, the guide inner profile has a generally C-shaped basic shape in cross section (see FIGS. 16 and 19). The rail 50 can be made of electrically conducive material, including, but not limited to, aluminum, iron, stainless steel, mild steel, and other various metals. Further, in some aspects, but not all, the rail 50 has a non-conductive outer layer, used to protect the electrically conducive inner layer from the elements. In other aspects, the rail 50 lacks a non-conductive outer layer. The profile rails 50 hold items used for fixing of photovoltaic solar modules 51 on mounting racks in its construction, e.g. on roofs. In an aspect, the profile rails 50 are mounted with a bias for optimum solar energy utilization at the installation site of the photovoltaic solar modules and photovoltaic solar modules are screwed to the profile rail retaining elements arranged in the guide inside profiles of the profile rails.

In most aspects, the rail 50 is profiled, leaving the interior of the rail 50 configured to receive and retain the retaining element 1. As shown in FIGS. 15-19, the retaining element 1 is suitable for the arrangement in a cross-section in a C-shaped basic form guide inner profile (in the vertical direction) of a profile rail 50. In an aspect, the cross-section of the rail 50 forms a C-shaped basic profile, with an additional inner rail 53 of the rail 50. The inner rail 53 is widened at both ends of the C-shaped basic form inside. The bottom portion 50b of the rail 50 can also include side outer rails 56. The outer rails 56 are configured to engage mounting devices used for connection of the rail 50 to surfaces (e.g., roofs, support structures, etc.). The outer rails 56 can be formed out of the bottom portion 50b of the rail 50, with the outer rails 56 protruding into the inner profile of the rail 50, creating a bottom channel 57.

As shown in FIGS. 15-16 and 19, the interior profile of the rail 50 can include an upper channel 52 and a lower channel 54 divided by the inner rail 53. The inner rail 53 includes an upper surface 53a on which the bottom of the retainer cap 2 can engage. In addition, the inner rail 53 includes a lower surface 53b that includes a surface for which the upper surface 11 of the base member 6 to engage. The upper channel 52 can be defined by the top surface of the rail 50 to the upper surface 53a of the inner rail 53. The lower channel 54 can be defined by the bottom surface 53b of the inner rail 53 and upper surfaces of the outer rails 56 that extend into the profile of the rail 50. In an aspect, the upper channel 52 is shaped to retain the flexible platform 3 of the retainer cap 2, and the lower channel 54 is shaped to retain the base member 6 when mounted within the profile of the rail 50, discussed below.

In an aspect, when mounting the holding element 1 to the rail 50, the retainer cap 2 and the base member 6 are connected to one another before being placed within the inner profile of the rail 50. More specifically, the interior of the space collar 9 of the retainer cap 2 encompasses the neck attachment 20 of the base member 6, with the centrally located aperture 4 of the retainer cap 2 aligned with the base aperture 40 of the base member 6. The space collar 9 is placed onto the neck attachment 20 until the latching arms 22 engage the nibs 24 (the nibs 24 received by the arm apertures 22a) to secure the retainer cap 2 to the base member 6. Once secured, the width W1 of the retainer cap 2 and the length L2 of the base member 6, along with the length L1 of the retainer cap 2 and the width W2 of the base member 6, are aligned substantially in parallel with one another respectively (see FIG. 1).

Once the retainer cap 2 and the base member 6 are connected, the retaining element 1 is then placed within the inner profile of the rail 50. In order to fit, the slide plate 10 is placed first into the upper channel 52 of the rail 50, and passes through the inner rail 53 into the lower channel 54. In order to fit, the slide plate 10 is placed initially so that the length L2 side is aligned in parallel with the rail 50. The slide plate 10 is lowered into the lower channel 54 until the arms 7 of the retainer cap 2 engage the top surface of the rail 50.

Once the arms 7 of the retainer cap 2 engage the top surface of the rail 50, the retaining element 1 is then turned approximately 90° so that the arms 7 rotate and engage the inner profile of the rail 50 within the upper channel 52. The notches 3a of the retainer cap 2 allow the shoulders 8 to sit along the top surface of the rail 50 while the arms 7 are substantially received within the upper channel 52. When the retaining element 1 is rotated approximately 90°, the base member 6 is rotated such that the length L2 side of the base member 6 is perpendicular to the rail 50. In this orientation, the fixing elements 16 are aligned with mating surfaces (e.g., the lower surface 53b of the inner rail 53) of the rail 50, allowing an electrical connection to form between the rail 50 and the base member 6. In an aspect, the rounded edges/corners 10a of the slide plate 10 allow the base member 6 to rotate 90° while preventing the base member 6 from over rotating (i.e., the substantially flat side surfaces of the slide plate 10 engage the walls of the inner profile of the railing 50). The connector 41 can be placed within the apertures 4, 40 of the retainer cap 2 and base member 6 before or after the combination retainer cap 2/base member 6 is placed within the rail 50.

When the cap retainer 2 and the base member 6 are secured to one another without the connector 41 fully tightened with the solar component 51, the retaining element 1 can slidably move within the rail 50 until the connector 41 is fully tightened. In aspects where the retainer cap 2 is slightly curved, when the connector 41 is tightened, the flexible platform 3 of the retainer cap 2 begins to flex so that the curve of the flexible platform 3 decreases with more of the bottom surface of the platform 3 engaging the upper surface of the rail 50. In addition, as the connector 41 is tightened, the fixing elements 16 will engage the inner rail 53, preventing the retaining element 1 from sliding within the rail 50.

Looking at FIGS. 15-19, when the slide plate 10 is inserted into the rail 50, it will be proximate a rail surface, such as the lower surface 53b of the inner rail 53, or some similar surface. Each fixing element/protuberance 16 is made of a material whose mechanical properties allow the mating surface of the rail 50 (e.g., the lower surface 53b of the inner rail) to be penetrated to create a mechanical and electrical connection between the rail 50 and the retaining element 1. The penetration is achieved by tightening of the connector 41. In some aspects, as discussed above, the rail 50 includes a non-conductive layer through which the fixing element/protuberance 16 can penetrate. In such aspects, the fixing element/protuberance 16 penetrates the non-conductive and conductive layers of the rail 50 to create the mechanical and electrical connection. After the non-conductive layer of the rail 50 is penetrated, the electrically conductive material of the slide plate 10 is in contact with the electrically conductive material of the rail 50 or other structural component. In aspects in which the rail 50 does not have a non-conductive layer, the fixing elements 16 engage and penetrate the surfaces of the rail 50, assisting in the electrical connection as well as the mechanical connection. In exemplary aspects, the fixing elements 16 can be of a material that can penetrate the material of the rail 50 to anchor the retaining element 1 at the location of the rail 50.

Since the retaining element 1 may be used to secure photovoltaic solar panels 51 or other racking components 51 to the rail 50, components of the base member 6 need to have sufficient strength to withstand the force necessary to hold all of the components of the retaining element 1 (i.e., the retainer cap 2, connector 41, and base member 6) with the rail 50 and solar components 51 together without the base member 6, and specifically the neck attachment 20, fracturing. This resistance to mechanical failure can be achieved by forming the base member 6 of a base metal, for example, through a casting, forging, or other forming process. However, it is preferable for the components of the retaining element 1, including the retainer cap 2, base member 6, and connector 41, to each be constructed from a single piece of substantially hard metallic material including, but not limited to, carbon steel, stainless steel, titanium, or any other suitable material, such as manufacture by cold forming, turning or forging. While other materials can be used for the construction of the retainer cap 2 and the base member 6, it is preferable that these components be of hard metallic material to ensure that they do not break under the stress of containing the rail 50 and solar components 51 together. Further, it is desirable that the material used for the formation of the connector 41 and the base 6 are electrically conductive. Also, given the type of fastening experienced by the retainer cap 2 with the base member 6, it is preferable, but not required, that the base member 6 be formed from a very strong metal, for example, an iron alloy, to avoid component failure when inserted into, tightened, and retained within the rail 50.

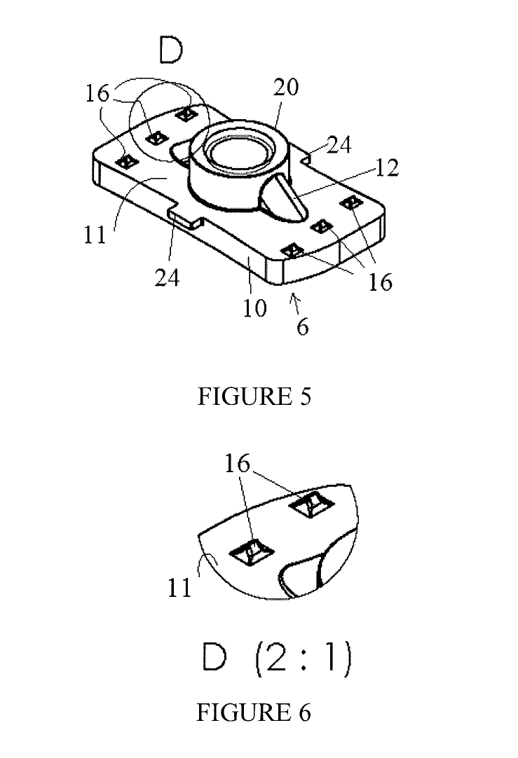

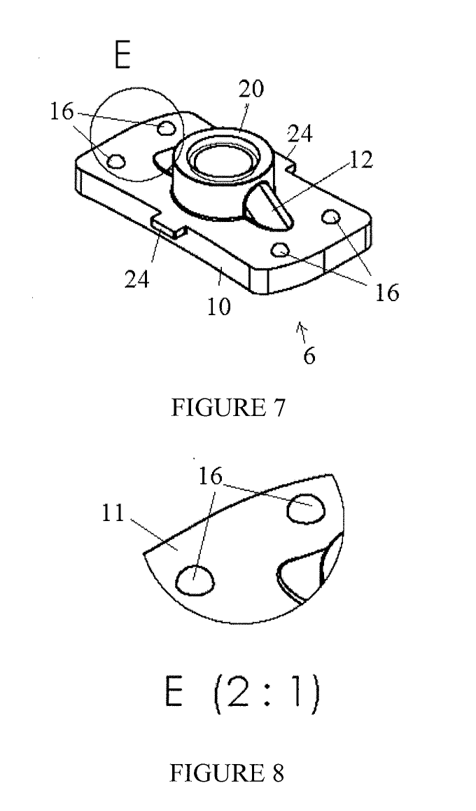

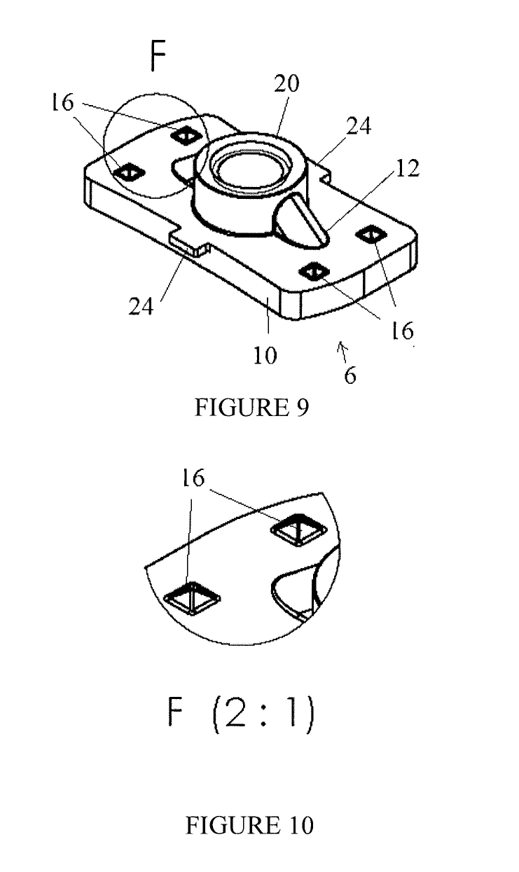

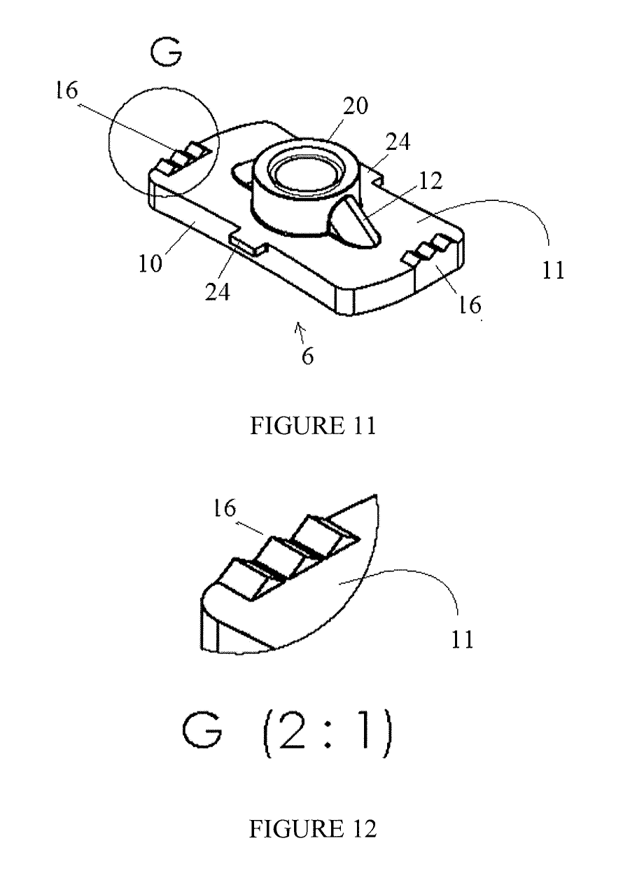

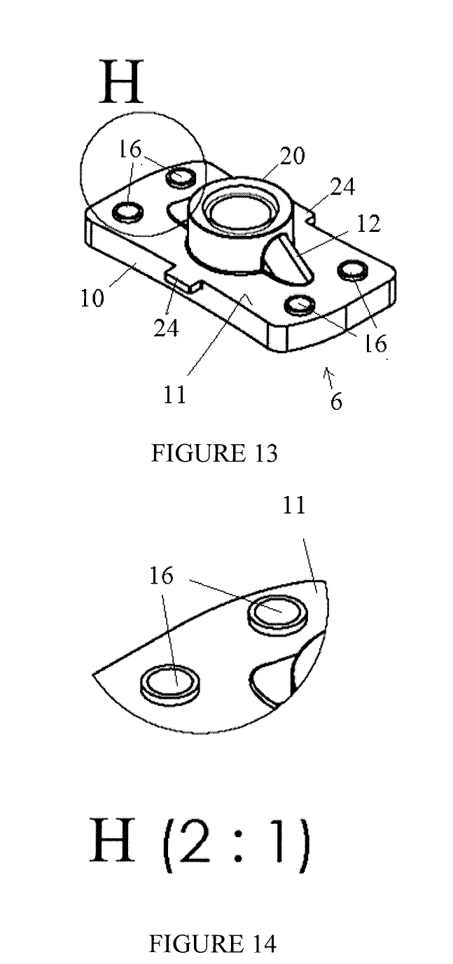

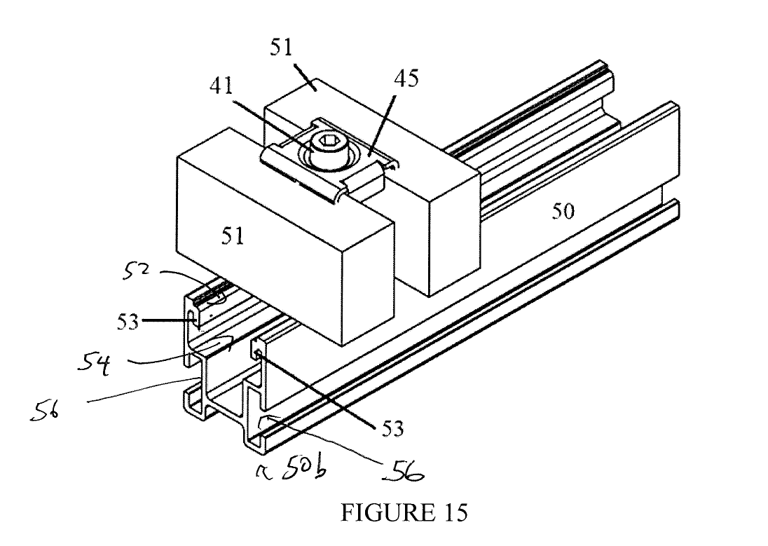

As shown in FIGS. 4-14, the fixing elements 16 can comprise protuberances 16. The protuberances 16 can have different polygon or other geometric shapes, including, but not limited to, hemispherical (FIGS. 4 and 7-8), pin, square, ring (FIGS. 13-14), prismatic, ramp (FIGS. 5-6), conical, triangular (FIGS. 11-12), and pyramidal (FIGS. 9-10). The protuberances 16 can be convex shaped and have one or more apices. In addition, the number of fixing elements/protuberances 16 can vary on the upper surface 11 of the slide plate 10 of the base member 6 as well. FIGS. 7 and 8 illustrate substantially hemispherical protuberances 16. In an aspect, the fixing elements 16 can be positioned equidistant around the upper surface 11 of the slide plate 10 of the base member 6. And while the positions of the fixing elements 16 can vary on the top surface 11 of the slide plate 10, the fixing elements 16 can be positioned along the portions that will engage the mating surfaces of the rail 50 when the base member 6 is placed within the inner profile of the rail 50.

In an aspect, the fixing elements 16 are made from a substantially hard metallic material that can penetrate the materials of the rail 50. In an aspect, those materials of the rails 50 can include a non-conductive layer or skin on a rail 50, as well as a conductive inner layer of the rail 50. The penetration is achieved by tightening the connector 41 to achieve a sufficient force so that the protuberance 16 will engage and extend through the non-conductive layer if present and penetrate the conductive material of the rail 50. After the penetration, either through a non-conductive layer and a conductive layer, or just a conductive layer, the electrically conductive material of the base member 6 is in contact with the electrically conductive material of the rail 50. The combination of the base member 6 and the connector 41 therefore makes an electrical and mechanical connection with the rail 500 and the other structural component 51.

Having thus described exemplary embodiments of the retaining element 1 to provide an electrical and mechanical connection with the rail 50, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A retaining element for forming a mechanical and electrical connection between a solar component and a rail, the retaining element comprising:
a retainer cap;
a base member, wherein the base member comprises at least one fixing element; and
a connector, wherein the retainer cap and the base member are configured to be connected to one another to be received within an inner profile of a rail, wherein the rail has a conductive layer, wherein the connector is further configured to connect the solar component to the retainer cap and the base member, and the at least one fixing element is configured to create the mechanical and electrical connection between the solar component and the rail.

2. The retaining element of claim 1, wherein the at least one fixing element is positioned on an upper surface of the base member, wherein the at least one fixing element comprises a protuberance that is geometric shaped.

3. The retaining element of claim 2, wherein the one or more geometric shaped protuberance is selected from the group of a hemispherical shape, pin shape, ring shape, prismatic shape, ramp shape, cone shape, square shape, and pyramidal shape.

4. The retaining element of claim 2, wherein the protuberance is a polygon shape with at least one apex.

5. The retaining element of claim 4, wherein the protuberance is convex.

6. The retaining element of claim 1, wherein the at least one fixing element is made from a substantially hard and electrically conductive material.

7. The retaining element of claim 6, wherein the at least one fixing element is configured to penetrate a non-conductive layer of the rail to reach the conductive layer of the rail to form the electrical connection.

8. The retaining element of claim 7, wherein the at least one fixing element is configured to penetrate the non-conductive layer of the rail when the connector is tightened.

9. The retaining element of claim 1, wherein the retainer cap comprises:
a flexible platform with a top surface;
an aperture centrally located in the flexible platform; and
a space collar extending opposite the top surface, the aperture extending through the space collar;
wherein the base member comprises:
a slide plate having the upper surface;
a neck attachment extending upward on an upper surface of the base member;
a base aperture extending through the next attachment and slide plate, wherein the neck attachment is configured to be received by the space collar, with the base aperture and the aperture of the retainer cap are configured to align with one another to receive the connector.

10. The retaining element of claim 9, wherein the rail comprises an inner profile containing an inner rail, wherein the inner rail forms an upper channel and a lower channel within the inner profile of the rail, the upper channel configured to engage the retainer cap and the lower channel configured to engage the base member, wherein the at least one fixing element is configured to engage a lower surface of the inner rail.

11. The retaining element of claim 10, wherein the slide plate further comprises rounded corners, the rounded corners configured to allow the base member to rotate to a limit of approximately 90 degrees with received within the lower channel of the rail.

12. The retaining element of claim 11, wherein the flexible platform further comprises at least one arm configured to engage an upper surface of the inner rail when placed within the profile of the rail.

13. A mechanical and electrical connection system for solar panel support components, the system comprising:
a retaining element comprising:
a retainer cap;
a base member, wherein the base member comprises at least one fixing element; and
a connector; and
a rail comprising:
a conductive layer;
an inner profile; and
an inner rail within the inner profile, the inner rail having an upper surface and a lower surface, wherein the inner rail forms an upper channel and a lower channel within the inner profile of the rail, wherein the retaining element is configured to be received within the inner profile of the rail.

14. The system of claim 13, wherein the at least one fixing element comprises a protuberance made from a substantially hard and electrically conductive material.

15. The system of claim 14, wherein the protuberance is configured to penetrate the conductive layer to make an electrical connection between the retaining element and the rail.

16. The system of claim 15, wherein the rail further comprises a non-conductive outer layer surrounding the conductive layer, wherein the protuberance is further configured to penetrate the outer non-conductive layer.

17. The system of claim 16, wherein the protuberance comprises a plurality of protuberances, and wherein the plurality of protuberances are oriented on an upper surface of the base member of the retaining element, wherein the protuberances are configured to penetrate the non-conductive outer layer of the rail on the lower surface of the inner rail.

18. A rail for use with solar components, the rail comprising:
a conductive material; and
an inner profile comprising:
an inner rail comprising an upper surface and a lower surface, wherein the inner rail forms an upper channel and a lower channel within the inner profile, wherein the inner profile is configured to receive a retaining element that creates an electrical and mechanical connection with the railing, the retaining element, and the solar component.

19. The rail of claim 18, further comprising outer rails, wherein the outer rails are formed from and are oriented at a bottom portion of the rail, wherein the outer rails define a bottom channel within the inner profile of the rail.

20. The rail of claim 18, wherein the upper channel is defined by an upper surface of the rail and the upper surface of the inner rail.

21. The rail of claim 18, wherein the lower channel is defined partially by the lower surface of the inner rail.

22. The rail of claim 18, further comprising a non-conductive outer layer surrounding the conductive material, wherein the conductive material forms a conductive inner layer, wherein the mechanical and electrical connection is formed by the retaining element penetrating through the non-conductive outer layer to penetrate the conductive inner layer.
